(19) United States
(12) Patent Application Publication
(10) Pub. No.: US 2002/0177372 A1
(43) Pub. Date: Nov. 28, 2002

(54) CYLINDRICAL TERMINAL RIVET AND BATTERY SNAP

(76) Inventor: Steve Han Shi Hwang, Chungho City (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/880,812

(22) Filed: Jun. 15, 2001

(30) Foreign Application Priority Data
May 24, 2001 (TW) 90208534

(51) Int. Cl. H01R 4/28

(52) U.S. Cl. 439/754

(57) ABSTRACT

A cylindrical terminal rivet integrally made of metal comprises a base plate, a cylinder, and an elongated plate. The base plate provides a central hole and the cylinder with a closed upper end extends upright from the base plate and communicates with the central hole. The elongated plate extends outward from a lateral side of the base plate and provide at least a wing piece at two opposite edges thereof respectively. The cylinder is arranged to pass through a work piece and pressed to form a pancake like solid body so as to urge the work piece tightly and to block the central hole. Furthermore, a battery snap can be composed of two cylindrical terminal rivets, an insulation piece, a male engaging post, a female engaging post and a covering band.

### BACKGROUND OF THE INVENTION

1. Field of the Invention

The present invention relates to a terminal rivet, and particularly, to a cylindrical terminal rivet, which can avoid the foreign liquid such as the leaked liquid from the battery to pass through the-pierced holes therein and can strengthen the torque resistance after engaging with the work piece. Furthermore, the cylindrical terminal rivet can be used for a battery snap.

2. Description of Related Art

The quality of an electronic product usually depends on whether the design of components thereof and the assembling among the components are good or not. Especially, how to treat and join a so-called contact point or terminal properly is very important in the field of electronic industry.

Taking the battery box as an example, although it is not a high precision product, the contact point being unimpeded is a key feature affecting the function and the quality of an electronic product tremendously. Actually, it is a primary consideration for the battery box to offer a sufficient room for receiving the batteries so that it is not possible for the maker to treat the contact points thereof with a high precision or high cost.

Referring to FIG. 1, a conventional hollow terminal rivet 100 comprises a base plate 101, and the base plate 101 at the center thereof has a hollow rivet post 102 with a cylindrical hole 103 communicating with the base plate 101 so that the entire rivet post 102 can pass through a work piece. Besides, the base plate 101 at a lateral side thereof extends an elongated plate 104 with at least a wing piece 15 at both lateral edges thereof respectively for being pressed to join with an electric wire.

As soon as the rivet post 102 of the terminal rivet 100 is inserted into the work piece, the rivet post 102 can be pressed by a press machine to generate radial fracture so as to be expanded into a plurality of post pieces for fixing the work piece together with the base plate 101. The terminal rivet 100 is integrally made of a metal and the cylindrical hole 103 is not blocked after the riveting step. Thus, it results in that the foreign liquid or the liquid leaked from the battery due to a chemical reaction may pass through the cylindrical hole 103 to flow toward the circuit board and damage the electronic product. In addition, the conventional terminal rivet is fixed to the work piece by way of a plurality of radial fractured post pieces clamping the work piece together with the base plate so that an inferior quality of treatment may occur a deformed rivet and becomes rotatable on the work piece loosely. As a result, it leads to an improper contact finally. Moreover, the post pieces may seriously break and the whole terminal rivet may separate from the work piece uselessly.

### SUMMARY OF THE INVENTION

An object of the present invention is to provide a cylindrical terminal rivet, which has a cylinder to be compressed to form a pancake like solid body to block the engaging hole therein so as to prevent the foreign liquid from passing through the hole.

Another object is to provide a battery snap, which is basically composed of two cylindrical terminal rivets of the present invention such that no liquid can be flowed through engaging holes to damage related circuit board.

### BRIEF DESCRIPTION OF THE DRAWINGS

The present invention can be more fully understood by referencing to the following description and accompanying drawings, in which:

FIG. 1 is a perspective view of a conventional terminal rivet;

FIG. 2 is a perspective view of a cylindrical terminal rivet according to the present invention;

FIG. 3 is a sectional view of the cylindrical terminal rivet shown in FIG. 2;

FIG. 4 is a sectional view illustrating the cylindrical terminal rivet engaging after engaging with a work piece;

FIG. 5 is an exploded perspective view of a cylindrical terminal rivet of the present invention engaging with a battery snap; and

FIG. 6 is a sectional view of FIG. 5 after the cylindrical terminal rivet having engaged with the battery snap.

### DETAILED DESCRIPTION OF THE PREFERRED EMBODIMENTS

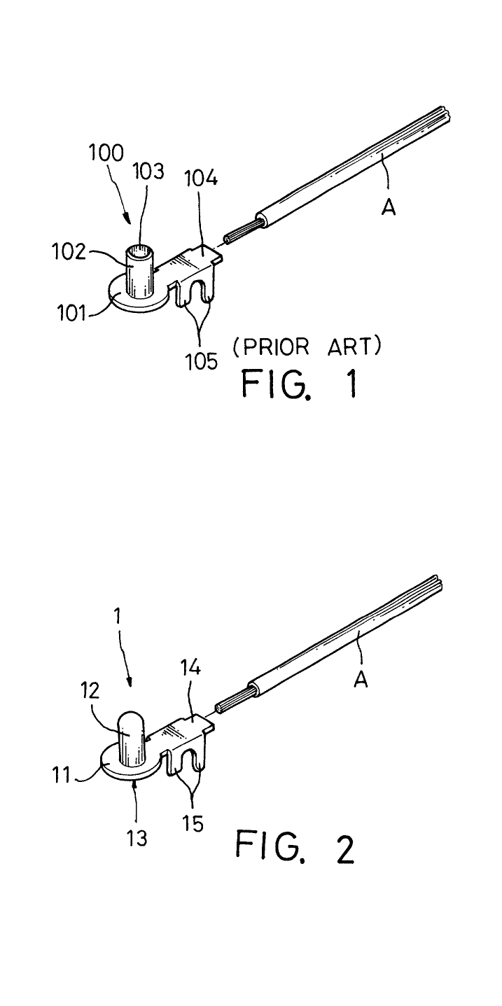

Referring to FIGS. 1 and 2, a cylindrical terminal rivet 1 is integrally made of a metal and formed by way of a base plate 11 providing an upright cylinder 12 at the center thereof and extending an elongated plate 14 laterally.

Wherein, the base plate 11 is circular and the upright cylinder 12 has a closed upper end so as to be inserted into a work piece. The base plate 11 has a central hole 13 to communicate with the upright cylinder 12. Beside, the elongated plate 14 extended from the base plate 11 has both opposite lateral edges thereof provide at least a wing piece IS respectively in accordance with the actual need.

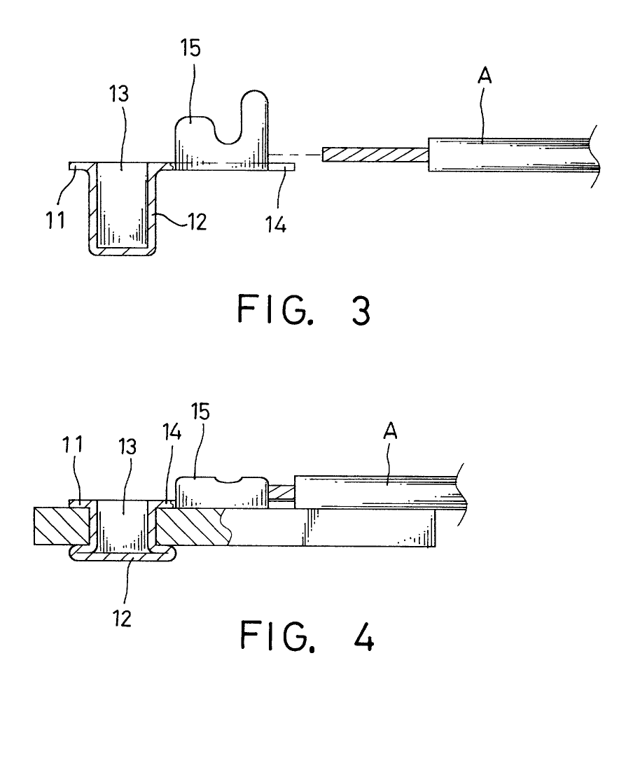

Referring to FIGS. 3 and 4, and accompanying with FIG. 2 again, as soon as the cylindrical terminal rivet of the present invention is going to engage with the work piece, a bare electrical wire A is placed on the elongated plate 14 first and then the wing pieces 15 is pressed to clamp the electric wire A tightly as a state of joining together firmly. Next, the cylinder 12 is arranged to pass through a preset engaging hole on the work piece such that the cylinder 12 can be pressed to form a circular solid body and surround the engaging hole 13 completely. In this way, the spot treated by the terminal rivet of the present invention can be entirely clamped by the compressed cylinder 12 and the base plate 11 tightly and firmly.

It is appreciated that the advantages of the present invention can be summarized hereinafter.

(1) The compressed cylinder with a shape of flat pancake can block the engaging hole such that the foreign liquid or the liquid from the battery due to a chemical reaction of the battery may not be admitted immediately to spread or flow deeply into the riveted spot. In this way, the liquid can be removed in a very short time to assure the life span of an electronic product.

(2) The compressed cylinder with a shape of flat pancake can urge the work piece entirely such that a structural strength can be increased substantially. For instance, the conventional hollow terminal rivet shown in FIG. 1 (The height thereof is about 2.5˜2.6 mm.) provides a maximum torque resistance of 0.5˜0.6 Kgf-cm after an experimental test being conducted. Nevertheless, the cylindrical terminal rivet of the present invention with a size being the same as the conventional terminal rivet provides a maximum torque resistance is 1.2˜1.3 Kgf-cm. Hence, the cylindrical rivet of the present invention can not loosen from the work piece easily after being pulled such that an excellent contact can be kept substantially.

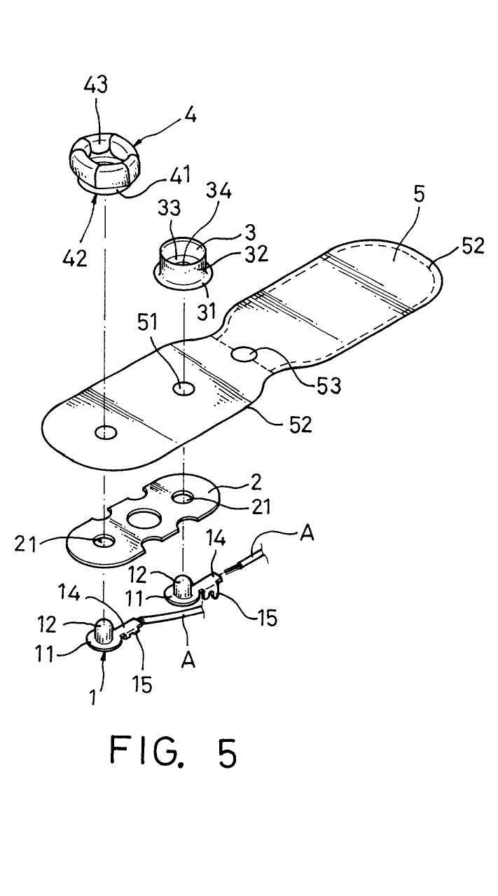

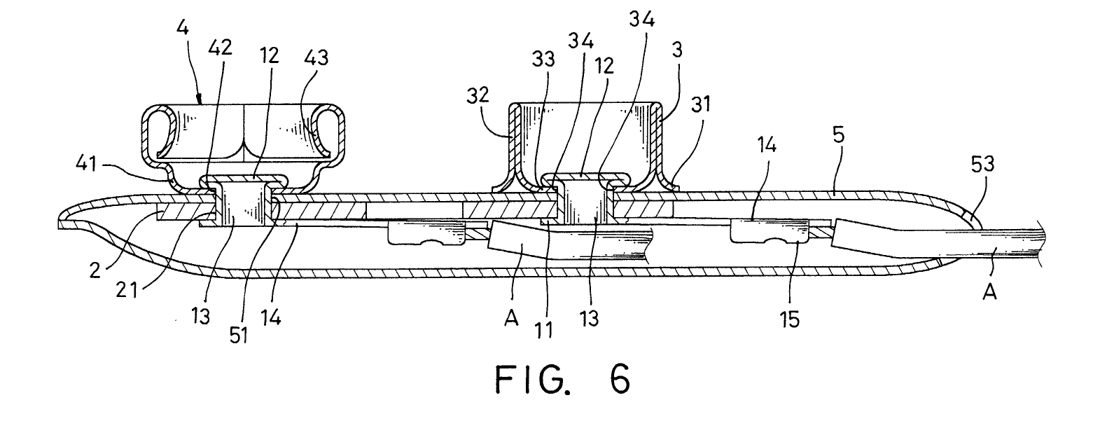

Referring to FIGS. 5 and 6, the cylindrical terminal rivet used for a battery snap is illustrated. The battery snap comprises two cylindrical terminal rivets 1, an insulation piece 2, a male engaging post 3, a female engaging post 4, and a covering band 5.

Wherein, the structure of the cylindrical terminal rivet has been described previously so that it would not be repeated again.

The insulation piece 2 is an insulation plate with two pole holes 12 corresponding to two poles of the battery respectively for being inserted by the cylinder 12.

The male engaging post 3 is made of a conductive metal and the lower edge thereof has a flange 31 and a cylindrical post 32 extends upward from the lower edge. Also, a lower ring 33 and a central hole 34 surrounded by the lower ring 33 are formed at the lower edge and the cylindrical post 32 has an outer diameter corresponding to a female snap part on the battery with a standard specification. The central hole 34 has a size corresponding to the outer diameter of the cylinder 12 such that the cylinder 12 is folded inversely as a shape of pancake to press over the lower ring 33 tightly after engagement.

The female engaging post 4 is integrally made of a conductive metal too and the lower part thereof extends downward an inward bottom 41 with a central hole 42 surrounded by the bottom 41 so as to be urged by the deformed cylinder 12. The female engaging post 4 at the upper part thereof is folded inversely inward to form a plurality of petal parts 43 for engaging with the male snap part of the battery. The size of the male snap part of the battery is made in accordance with the standard specification.

The covering band 5 is insulated and preferably made of a plastic sheet. A pierced hole 51 is provided to correspond to the pole hole 21 for being passed through by the cylinder 12. In order to prevent the insulation piece, the base plate 11 and the elongated plate 14 from exposing outside, the lower part of the covering band 5 is folded inversely and formed a border 52 by way of welding such that a fitting hole 53 is left for being passed over by the electric wire A.

Accordingly, as soon as the battery snap is assembled, a construct is formed as shown in FIG. 6 and it can be seen that the male engaging post 3 and the female engaging post 4 at the inner part thereof are urged by the deformed cylinder 12, which is compressed to form a circular solid piece, without loosening. The cylinders 12 can block the central holes 34, 42 respectively not to admit the liquid leaked from the battery entering the interior of the battery snap so that a phenomenon of oxidization can be refrained completely. Furthermore, a torque resistance can be increased due to two cylindrical terminal rivets 1 engaging with the male engaging post 3 and the female engaging post 4 respectively such that the two engaging posts may not become loosening or disengaging resulting from pulling once the battery snap separates from the battery.

While the invention has been described with reference to preferred embodiments thereof, it is to be understood that modifications or variations may be easily made without departing from the spirit of this invention, which is defined in the appended claims.

What is claimed is:

1. A cylindrical terminal rivet integrally made of metal, comprising:
a base plate with a lateral side, providing a central hole;
a cylinder, extending upright from the base plate, communicating with the central hole, and providing a closed upper end; and
an elongated plate with two opposite edges, extending outward from the lateral side, providing at least a wing piece at said two opposite edges respectively;
whereby, the cylinder is arranged to pass through a work piece and pressed to form a pancake like solid body so as to urge the work piece tightly and to block the central hole.

2. The cylindrical terminal rivet according to claim 1, wherein said wing piece extends along with the upright cylinder or in a direction opposite to the upright cylinder.

3. A battery snap, comprising
two cylindrical terminal rivets, being integrally made of metal, each of the cylindrical terminal rivet further comprising a base plate with a lateral side providing a first central hole, a cylinder with a closed upper end extending upright from the base plate and communicating with the first central hole, and an elongated plate with two opposite edges extending outward from the lateral side and providing at least a wing piece at said two opposite edges respectively;
an insulation piece with a plate shape, providing two pole holes, a distance between said two pole holes corresponding to a distance between two poles of a battery;
a male engaging post, being integrally made of a conductive metal, a lower edge thereof having a flange and a cylindrical post extending upward from the lower edge, a lower ring with a second central hole therein being pierced by the cylinder, the cylinder being pressed to form a shape of pancake urging the flange tightly and blocking the second central hole, and the cylindrical post engaging with a female snap part;
a female engaging post, being integrally made of a conductive metal, a lower part thereof extending downward an inward bottom with a third central hole being pierced by another one of the cylinders, the another cylinder being pressed to form a pancake like solid body so as to urge the bottom and block the third central hole, the upper part thereof being inward folded inversely to form a plurality of petal parts for engaging with a male snap part of the battery.

4. The battery snap according to claim 3, further comprises a covering band made of insulation material, providing two through holes corresponding to the two pole holes; an upper band part thereof being disposed between the insulation piece and the male and the female engaging posts; and a lower band part thereof being folded inversely and forming a border by way of welding, a fitting hole being provided to be passed over by an electric wire; whereby, the insulation piece, the base plate, and the elongated plate can be concealed.

5. The battery snap according to claim 3, wherein said wing piece extends along with the upright cylinder or in a direction opposite to the upright cylinder.
